(19) United States
(12) Patent Application Publication
(10) Pub. No.: US 2014/0360359 A1
(43) Pub. Date: Dec. 11, 2014

(54) Rotary Piston

(71) Applicants: Liessel Roland, Waldkraiburg (DE); Wolfgang Nindel, Muehldorf (DE); Bernhard Murrenhoff, Buchbach (DE); Robert Kurz, Aschheim (DE); Reinhard Denk, Muehldorf (DE); Josef Strassl, Straubing (DE); Thomas Boehme, Waldkraiburg (DE); Hisham Kamal, Waldkraiburg (DE); Stefan Weigl, Muehldorf am Inn (DE); Roger Willis, Mettenheim (DE); Stefan Kern, Haag (DE); Johann Kreidl, Waldkraiburg (DE); Gunther Herr, Haarth (DE); Marcel Verhoeven, Hailsham East Sussex (GB); Franz Kneidl, Waldkraiburg (DE); Mikael Tekneyan, Waldkraiburg (DE); Matthias Gradl, Sesslach (DE); Erwin Weber, Ampfing (DE)

(72) Inventors: Liessel Roland, Waldkraiburg (DE); Wolfgang Nindel, Muehldorf (DE); Bernhard Murrenhoff, Buchbach (DE); Robert Kurz, Aschheim (DE); Reinhard Denk, Muehldorf (DE); Josef Strassl, Straubing (DE); Thomas Boehme, Waldkraiburg (DE); Hisham Kamal, Waldkraiburg (DE); Stefan Weigl, Muehldorf am Inn (DE); Roger Willis, Mettenheim (DE); Stefan Kern, Haag (DE); Johann Kreidl, Waldkraiburg (DE); Gunther Herr, Haarth (DE); Marcel Verhoeven, Hailsham East Sussex (GB); Franz Kneidl, Waldkraiburg (DE); Mikael Tekneyan, Waldkraiburg (DE); Matthias Gradl, Sesslach (DE); Erwin Weber, Ampfing (DE)

(21) Appl. No.: 14/464,526

(22) Filed: Aug. 20, 2014

Related U.S. Application Data
(63) Continuation of application No. PCT/EP2013/053271, filed on Feb. 19, 2013.

(30) Foreign Application Priority Data
Feb. 20, 2012 (DE) 102012003287.0

(51) Int. Cl. F02F 3/28

(52) U.S. Cl. CPC F02F 3/28
USPC 92/177

(57) ABSTRACT

A rotary piston for a rotary piston pump includes at least one supporting body, through which a rotational axis of the rotary piston extends, and at least one end cap section, which is disposed radially outwards from the at least one supporting body and is connected flexibly, preferably elastically, to the at least one supporting body.

### FIELD OF THE INVENTION

The invention relates to a rotary piston for a rotary piston pump.

### BACKGROUND OF THE INVENTION

Rotary piston pumps are known from the prior art and disclosed for example in document DE 102 010 014 248 A1. The rotary piston pump according to this document comprises a motor and a pump housing in which the rotary pistons are disposed. Furthermore, inflow openings and outflow openings are provided in the pump housing. The two rotary pistons disposed in the housing rotate in opposite directions in order to be able to draw in a medium to be conveyed with permanent mutual contact.

If a medium comprising solids is to be conveyed by a rotary piston pump, increased wear can occur on the rotary pistons in the pump housing, which can lead to destruction of the rotary pistons. Increased maintenance expenditure is therefore required when such media are conveyed.

Document DE 37 07 722 A1 describes a rotor pump, which is also suitable for conveying liquids containing solids. With this prior art, the rotary pistons of the rotary piston pump are provided with a supporting body made of steel, referred to there as a wing, to which three elastic sealing strips are attached in each case. The sealing strips are formed as a whole from elastic material, for example from rubber or from plastic, and are attached rigidly to the supporting body by means of a friction-locked or form-fit connection. In the presence of high loading, in particular when media containing solids are conveyed, the respective strips become deformed depending on the loading. This prior art also makes provision such that, in the case of particularly high loading, which could possibly lead to blocking of the rotor by foreign bodies, shearing off of the connection means between the strips and the supporting body takes place. It has been shown with this prior art that the strips made of elastomer material are subject to severe wear. Moreover, it is also counter-productive in the operation when, in the case of a high load, the risk actually exists of the strips becoming detached from the supporting body due to rupturing of the predetermined rupture points. This can lead to a total defect and massive damage to the rotary piston pump.

The two documents DE 1 807 392 A1 and DE 2 056 661 A1 each describe rotary piston pumps, wherein the rotary piston is provided with a supporting body and a plurality of end cap sections, wherein the individual parts are protected against aggressive media by the fact that they are surrounded by enamelling and, in sections, also by a plastic casing. The creep tendency of the employed plastic and a resultant adverse effect on the function of the pump are thus intended to be prevented.

### SUMMARY OF THE INVENTION

It is a problem of the present invention to make available a rotary piston for a rotary piston pump, with which the wear on the rotary pistons can be reduced and the maintenance intervals extended and the downtimes of the rotary piston pump reduced.

This problem is solved with a rotary piston for a rotary piston pump with the features according to the independent claims.

Further embodiments of the invention can be seen from the dependent claims.

The rotary piston according to the invention comprises at least one supporting body, through which a rotational axis of the articulated body extends, and at least one essentially dimensionally stable end cap section. The at least one end cap section is disposed radially outwards from the at least one supporting body and is connected flexibly, preferably elastically, to the at least one supporting body. With the flexible, in particular elastic, connection of the at least one supporting body and the at least one end cap section, the mobility of solids in a rotary piston pump provided with the rotary piston according to the invention is increased, since the flexibility of the connection between the at least one, in itself dimensionally stable, end cap section and the at least one supporting body permits deflections or displacements of the at least one end cap section relative to the at least one supporting body. Deflections and tilting of the at least one end cap section relative to the supporting body in the direction of the rotational axis of the rotary piston, normal to the rotational axis and about the rotational axis are permitted depending on the current loading situation during operation.

Since the flexible, in particular elastic, connection between the at least one end cap section and the at least one supporting body is flexible in a predetermined manner, the at least one end cap section can be deflected or displaced relative to the at least one supporting body in the presence of the force effects occurring during operation of the rotary piston, especially when a medium comprising solids is being conveyed, in such a way that, in particular, the loading caused by the solids and friction between the rotary pistons of a rotary piston pump and between the rotary pistons and the pump housing are reduced. The at least one end cap section does not thereby become deformed, or only to a negligible extent. It can be constituted correspondingly solid, for example made of steel.

Jamming of the rotary pistons in the pump housing caused by the medium can also be prevented with the rotary piston according to the invention. In the case of conventional rotary pistons, solids for example can get jammed between the outer peripheral surface of a rotary piston and the pump housing, as a result of which, in the most unfavourable case, the rotary piston pump becomes blocked and the conveying of the medium to be conveyed is interrupted. Alternatively, the prior art reveals markedly deformable rotary piston components, which undergo a permanent deformation due to the forces occurring and may therefore wear rapidly. Since, in the case of the rotary piston according to the invention, the at least one dimensionally stable end cap section and the at least one supporting body are connected to one another elastically or flexibly, the at least one end cap section and the elastic connection with the at least one supporting body can give way or be deflected. Jamming of the rotary piston and the rotary piston pump caused by the solids in a medium to be conveyed is thus prevented.

With the rotary piston according to the invention, the wear on the rotary pistons can be reduced and also a continuous delivery of media containing solids through the rotary piston pump can be guaranteed. Rotary pistons with two or three end caps are preferably used.

The at least one supporting body constituted multi-part or single-piece and the at least one end cap section can be connected to one another by means of at least one elastomer cushioning layer in order to produce an elastic connection.

In an embodiment of the invention, the rotary piston can comprise at least two end cap sections, which are connected to one another by means of at least one loop packet or at least one loop. The at least one loop packet or the at least one loop are passed between the two end cap sections disposed radially outwards from the supporting body, in such a way that a connection to the at least one supporting body is produced.

The at least one loop packet, which connects the at least two end cap sections to one another or also only with the supporting body, can extend along the at least one supporting body. The at least one supporting body can for example comprise guide grooves, into which the at least one loop packet is guided at least in sections along the at least one supporting body. The at least two end cap sections each comprise for this purpose at least one coupling means, around which a loop is formed by the at least one loop packet. In other words, the loop packet is looped around the at least one coupling means on one of the end cap sections, extends proceeding from there along the at least one supporting body and is looped around the at least one coupling means on the respective other end cap section.

According to another embodiment of the invention, the at least one supporting body and the at least one end cap section can be connected to one another by means of at least one loop packet, i.e. the at least one loop packet extends between the at least one supporting body and the at least one end cap section.

The at least one loop packet and the elastomer cushioning layer are provided for an articulated or flexible connection of the at least one end cap section to the supporting body, which simultaneously permits displacements and deflections of the at least one end cap section relative to the supporting body in the direction of the rotational axis and normal to the rotational axis, but also about the rotational axis.

Furthermore, the supporting body and the at least one end cap section can be constituted such that the at least one end cap section can be supported in the case of a displacement in a direction towards the rotational axis—with compression of the cushioning layer on the supporting body.

During operation of the rotary piston, the at least one loop packet is primarily loaded with tensile forces. If, on account of the loads occurring during operation of the rotary piston, the at least one end cap section is deflected for example in a direction outwards and normal to the rotational axis of the rotary piston, the at least one loop packet is subjected to tensile load and limits, according to a predetermined deflection path, further deflection of the at least one end cap section relative to the supporting body. Any damage to the elastomer cushioning layer is thus prevented.

The at least one supporting body and the at least one end cap section can be connected to one another by means of at least one loop packet arrangement. The loop packets of the at least one loop packet arrangement can be disposed offset relative to one another in the axial direction of the rotary piston. The loop packets of the loop packet arrangement can moreover be disposed distributed over the axial extension of the at least one supporting body in the direction of the rotational axis. Furthermore, the loop packets of the at least one loop packet arrangement can also be disposed in a plane which runs normal to the rotational axis of the rotary piston.

The loop packets of the at least one loop packet arrangement can be disposed on the at least one supporting body and the at least one end cap section in such a way that at least two loop packets of the at least one loop packet arrangement intersect. In this embodiment, the loop packets intersect in a region between the at least one supporting body and the at least one end cap section.

The loop packets of the at least one loop packet arrangement can however also be disposed on the at least one supporting body and the at least one end cap section in such a way that the loop packets of the at least one loop packet arrangement runs parallel to one another between the at least one supporting body and the at least one end cap section.

In order to be able to produce the connection between the at least one supporting body and the at least one end cap section by means of the at least one loop packet, at least one coupling means can be provided in each case on the at least one supporting body and the at least one end cap section. The coupling means of the at least one supporting body and of the at least one end cap section are looped around by the at least one loop packet of the at least one loop packet arrangement. The coupling means can for example be constituted in the manner of a projection or bolt-shaped and extend through predetermined openings on the at least one supporting body and/or on the at least one end cap section or are accommodated in these openings. However, other forms of coupling means are of course also conceivable.

Apart from the guidance options for the loop packets described above, it is also possible according to an embodiment of the invention to loop all the loop packets of the at least one loop packet arrangement around at least one coupling means of the at least one end cap section. For this purpose, the loop packets of the at least one loop packet arrangement are connected, for example by means of coupling means at various coupling points, to the at least one supporting body and extend, proceeding from their coupling points on the supporting body, in the direction of the at least one coupling means on the at least one end cap section. In other words, in this variant of embodiment, all the loop packets of the at least one loop packet arrangement converge at the at least one coupling element of the end cap section and are looped around the latter.

According to a development of the invention, the at least one loop packet can be passed around at least one guide element. The guide elements can, by means their shape, assist the deflections of the at least one end cap section relative to the at least one supporting body in a predetermined direction, e.g. about the rotational axis of the rotary piston. The at least one guide element can for example be constituted arched.

According to an embodiment, the at least one loop packet can be embedded at least in sections in the at least one elastomer cushioning layer. The rotary piston is preferably encapsulated with an elastomer material in predetermined sections, so that the loop packets are embedded therein. The rotary piston thus obtained then undergoes a vulcanisation process, such as is known per se from elastomer processing.

According to a further embodiment of the invention, the at least one supporting body and the at least one end cap section can be connected to one another in a form-fit manner. The form-fit connection can be constituted such that the at least one supporting body and the at least one end cap section comprise at least one complementary pair of at least one projection and at least one recess. A dovetail-shaped connection between the at least one supporting body and the at least one end cap section to produce a form-fit connection is conceivable here, amongst others. By means of such a form-fit connection, the at least one end cap section can be supported on the supporting body after a predetermined deflection path with simultaneous compression of the cushioning layer, independently of the direction or the nature of the deflection or displacement relative to the supporting body.

The present invention also relates to a rotary piston pump with at least one rotary piston according to the kind described above.

### BRIEF DESCRIPTION OF THE DRAWINGS

Exemplary embodiments of the invention are described in detail below with the aid of the appended figures. In the figures:

FIGS. 1 to 4 show views of a rotary piston according to a first embodiment of the invention;

FIGS. 5 to 8 show views of a rotary piston according to a second embodiment of the invention;

FIGS. 9 to 12 show views of a rotary piston according to a third embodiment of the invention;

FIGS. 13 to 16 show views of a rotary piston according to a fourth embodiment of the invention;

FIGS. 17 to 20 show views of a rotary piston according to a fifth embodiment of the invention;

FIGS. 21 to 24 show views of a rotary piston according to a sixth embodiment of the invention;

FIGS. 25 to 28 show views of a rotary piston according to a seventh embodiment of the invention;

FIGS. 29 to 32 show views of a rotary piston according to an eighth embodiment of the invention; and

FIGS. 33a to 33f show the possible deflections of the end cap section of the rotary piston relative to the supporting body.

### DETAILED DESCRIPTION OF THE INVENTION

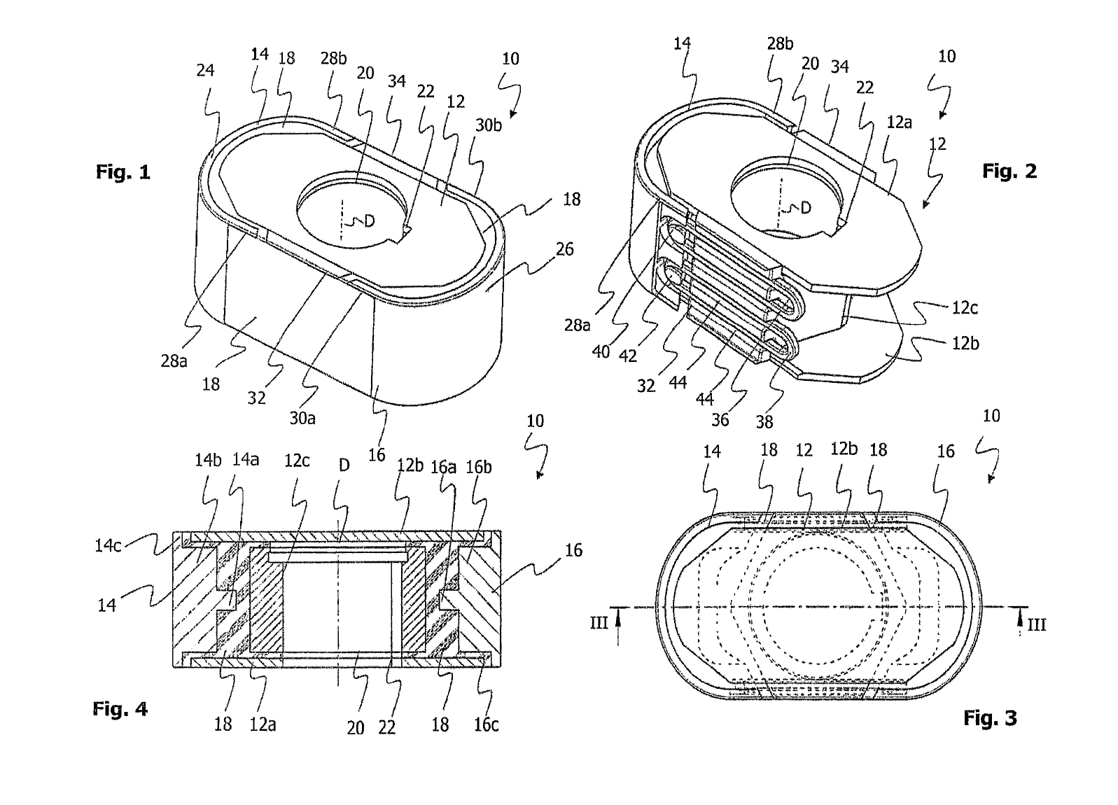

FIG. 1 shows a perspective view of a rotary piston 10 according to a first embodiment of the invention. Such a rotary piston 10 can be used for example in a rotary piston pump, such as is described in document DE 10 2010 014 248 A1.

Rotary piston 10 comprises a supporting body 12 and an end cap section 14 and 16 on each of its radially outer ends. Supporting body 12 is connected to end cap sections 14, 16 by means of an elastomer cushioning layer 18. Elastomer cushioning layer 18 is, as shown in FIG. 1, formed around supporting body 12.

Supporting body 12 further comprises an opening 20 forming the hub of rotary piston 10, said opening accommodating a shaft (not shown) for driving rotary piston 10 in a state of rotary piston 10 installed in a rotary piston pump. In order to be able to produce a connection to a shaft of the rotary piston pump (not shown), opening or hub 20 comprises a recess 22 in which a driver element or a feather key (not shown) can be accommodated.

As can be seen from FIG. 1, end cap sections 14 and 16 form at least in sections the wings of rotary piston 10. End cap sections 14, 16 thus limit the rotary piston radially outwards. End cap sections 14, 16 each comprise an essentially semicircular section 24, 26. Following semicircular sections 24, 26, end cap sections 14, 16 transform into straight connecting sections 28a, 28b and 30a, 30b, which each run, spaced apart by elastomer cushioning layer 18, parallel to faces 32 and 34 of supporting body 12. Faces 32 and 34 on supporting body 12 extend essentially parallel with one another and, just like connecting sections 28a, 28b and 30a, 30b, are coated with elastomer cushioning layer 18.

Elastomer cushioning layer 18 first runs in the region of semicircular sections 24 and 26 between supporting body 12 and end cap sections 14 and 16, before it covers parallel faces 32, 34 of supporting body 12 in order to encase loop packets 36, 38 (FIG. 2). Elastomer cushioning layer 18 forms a coating both for faces 32 and 34 of supporting body 12 and for connecting sections 28a, 28b and 30a, 30ba of end caps sections 14 and 16.

FIG. 2 shows a partially broken-away, perspective view of rotary piston 10.

According to this embodiment of the invention, supporting body 12 is constituted multi-part. Supporting body 12 comprises an upper plate 12a, a lower plate 12b and a base element 12c, which extends between plates 12a and 12b.

Loop packets 36 and 38 shown in FIG. 2 are used to connect end cap sections 14 and 16. Formed in connecting section 28a of end cap section 14 are coupling means 40, 42, around which loop packets 36, 38 are looped. Coupling means 40, 42 and also loop packets 36, 38 are disposed offset from one another in the direction of rotational axis D. Proceeding from coupling means 40, 42 on the end cap section 14, loop packets 36, 38 extend along face 32 of supporting body 12 or more precisely base element 12c of supporting body 12. For the purpose of guiding loop packets 36, 38, there are formed on face 32 guide grooves 44 which accommodate the strands of loop packets 36, 38 for their guidance. After running through guide grooves 44, loop packets 36, 38 loop around coupling means (not shown) on end cap section 16. The coupling means (not shown) on end cap section 16 can be constituted identical to coupling means 40, 42 on the end cap section 14.

When FIGS. 1 and 2 are viewed together, it can be seen that loop packets 36, 38, in the assembled state of rotary piston 10, are embedded in elastomer cushioning layer 18 or enclosed by the latter.

FIG. 3 shows a plan view of rotary piston 10 with supporting body 12 and end cap sections 14 and 16, wherein it can already be seen from FIG. 3 that plate 12b of supporting body 12 is not penetrated by opening 20, but rather forms a bottom for opening 20 and closes off the latter axially.

FIG. 4 shows a cross-sectional view of rotary piston 10 through cross-sectional line III-III in FIG. 3.

It is clear from FIG. 4 that opening 20, as mentioned, does not extend completely through supporting body 12, but is closed off by plate 12b. Opening 20 thus extends only through plate 12a and base element 12c of supporting body 12.

End cap sections 14 and 16 are constituted stepped and extend with their stepped sections 14a, 14b and 16a, 16b in a direction normal to rotational axis D of rotary piston 10 between plates 12a and 12b of supporting body 12. Elastomer cushioning layer 18 fills the regions between supporting body 12 and end cap sections 14, 16, so that supporting body 12 and end cap sections 14, 16 are connected in the direction of rotational axis D continuously via elastomer cushioning layer 18. By means of their extension normal to rotational axis D between plates 12a and 12b, deflections of end cap sections 14, 16 relative to supporting body 12 in the direction of rotational axis D can be limited by plates 12a and 12b, i.e. sections 14b and 16b of end cap sections 14, 16 can rest against plates 12a and 12b thereby compressing cushioning layer 18.

In a similar way, deflections of end cap sections 14 and 16 normal to rotational axis D are limited on rotational axis D by means of sections 14c and 16c of end cap sections 14, 16 and the peripheral edges of plates 12a and 12b. Sections 14c and 16c of end cap section 14, 16 can rest against the peripheral edges of plates 12a and 12b thereby compressing cushioning layer 18.

When FIGS. 1 to 4 are viewed in a comparative way, it can be seen that loop packets 36, 38 together with coupling means 40, 42 produce a direct connection between end cap sections 14, 16. A connection with supporting body 12 is also produced by means of loop packets 36, 38, since loop packets 36, 38 are accommodated or guided in guide grooves 44 of supporting body 12 and thereby covered by elastomer cushioning layer 18 or embedded in the latter.

Loop packets 36, 38, together with elastomer cushioning layer 18, ensure an articulated and flexible connection of end cap sections 14 and 16 to the supporting body, which simultaneously permits displacements or deflections of end cap sections 14 and 16 relative to supporting body 12 in the direction of rotational axis D and normal to rotational axis D, but also about the rotational axis. Furthermore, in the case of a displacement in a direction towards rotational axis D, end cap sections 14 and 16 can rest on supporting body 12 thereby compressing cushioning layer 18.

During the operation of rotary piston 10, loop packets 36, 38 are primarily loaded with tensile forces. If, on account of the loads occurring during operation of rotary piston 10, one of end cap sections 14, 16 is deflected for example in a direction outwards and in normal to rotational axis D, loop packets 36, 38 placed under tensile load and limit, according to a predetermined deflection path, the further deflection of one of end cap sections 14, 16 relative to supporting body 12.

Furthermore, loop packets 36, 38, together with elastomer cushioning layer 18 between supporting body 12 and end cap sections 14, 16, enable a restoring movement which, after the deflection of end cap sections 14, 16, returns the latter into their initial position.

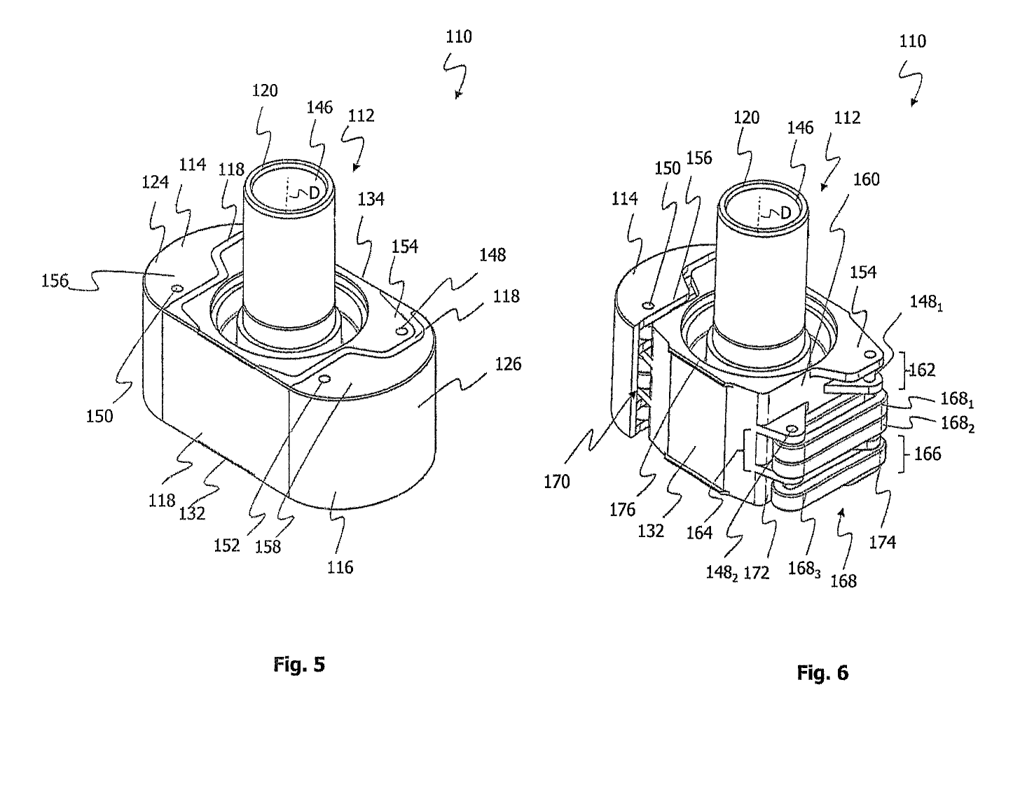

FIG. 5 shows a perspective view of a rotary piston 110 according to a second embodiment of the invention. The same reference numbers as previously are used in the following description for identical or identically operating components, but increased by 100.

Rotary piston 110 comprises a supporting body 112 and end cap sections 114, 116, which are connected to supporting body 112 via an elastomer cushioning layer 118.

Supporting body 112 according to the second embodiment of the invention comprises a tubular section 146, which extends in the direction of rotational axis D and forms, together with opening 120, the hub of rotary piston 110.

Coupling means 148, 150, 152 are provided on supporting body 112 and on end cap sections 114, 116. Coupling means 148, 150 and 152 are disposed on coupling projections 154 on supporting body 112 and on coupling projections 156 and 158 on the end cap sections. Coupling means 148, 150 are accommodated in openings, not described in detail, on coupling projections 154, 156, 158. Coupling projections 154, 156 and 158 are constituted correspondingly, so that, during operation of rotary piston 110, end cap sections 114 and 116 can rest on supporting body 112 thereby compressing cushioning layer 118.

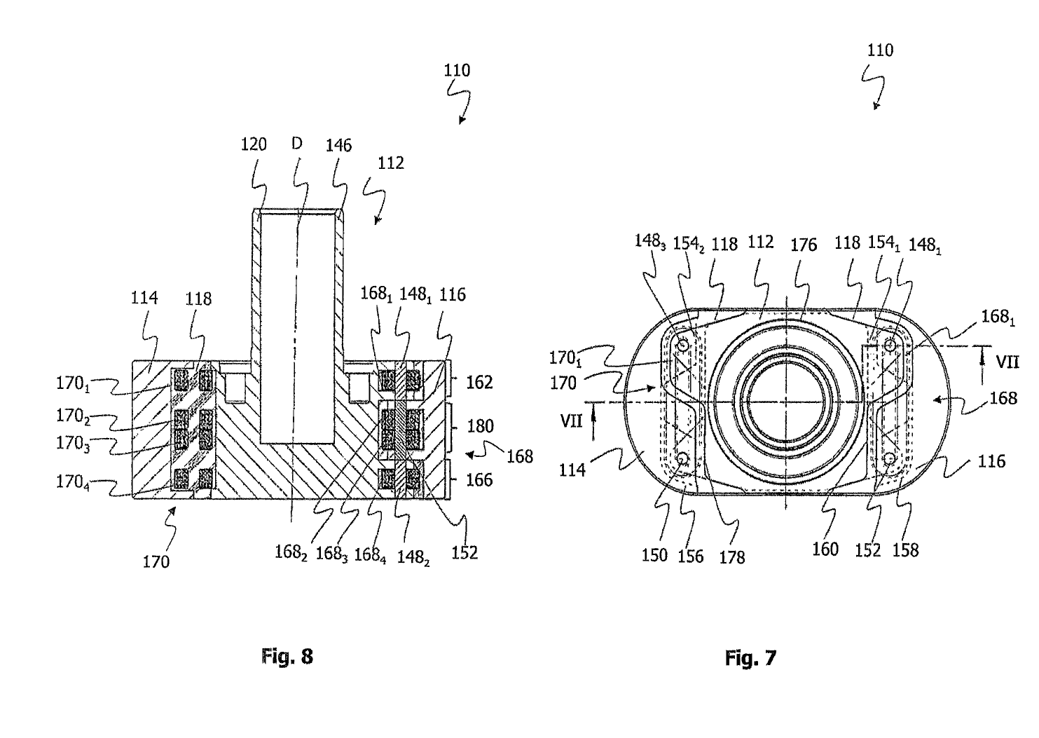

Turning now to FIG. 6, which shows a partially broken-away, perspective view of rotary piston 110, it can be seen that three coupling formations 162, 164, 166 are constituted on a face 160 of supporting body 112 that lies opposite end cap section 116 (FIGS. 5 and 7). Each coupling formation 162, 164, 166 comprises two coupling projections 154, whereof only one, as in FIG. 5, is denoted by 154 for reasons of clarity. Coupling formations 162, 164, 166 each accommodate a bolt-shaped coupling means 148₁ and 148₂.

Coupling means 148₁ and 148₂ couple a loop packet arrangement 168 with supporting body 112, wherein loop packet arrangement 168, together with elastomer cushioning layer 118, serves for the connection with end cap section 116 (FIGS. 5 and 8). Supporting body 112 is connected to end cap section 116 by means of a further loop packet arrangement 170 shown for the most part concealed in FIG. 6. According to this embodiment, coupling means 148₁ and 148₂ are constituted bolt-shaped and their length is matched to the dimensions of coupling formations 162, 164, 166.

Coupling formations 162, 164, 166 are disposed offset with respect to one another not only in the axial direction of rotational axis D, but are also disposed alternately at opposite ends 172 and 174 of face 160. Formations 162, 166 are disposed at the same end 174 of face 160, whereas coupling section formation 164 is disposed at end 172 of face 160.

According to the second embodiment of the invention, loop packets 168₁, 168₂ and 168₃ of loop packet arrangement 168 extend along face 160 between coupling section formations 162, 164 and 166 on supporting body 112 and corresponding coupling formations on end cap section 116 (FIG. 8).

Supporting body 112 comprises a recess 176, which surrounds radially tubular section 146 of rotary piston 110 and which can serve for example for the fitting and guidance of rotary piston 110 in a rotary piston pump (not shown). On face 132 of supporting body 112, it is possible to see strip-like projections at the axial ends of face 132 which serve to support elastic cushioning layer 118.

FIG. 7 shows a plan view of rotary piston 110 with supporting body 112.

Furthermore, it is possible once again to see in FIG. 7 coupling projections 154, 156, 158 on supporting body 112 and respectively end cap section 114, 116. Represented as dashed lines in FIG. 7 are loop packets 168₁ and 170₁ of the loop packet arrangements 168 and 170, which connect supporting body 112 respectively to end cap section 114 and end cap section 116. For this purpose, loop packet arrangements 168 and 170 extend between coupling projection 154₁ on supporting body 112 and coupling projections 156 on end cap section 114 and respectively between coupling projections 154₂ on supporting body 112 and coupling projections 158 on end cap section 116.

Loop packet arrangements 168 and 170 run parallel to faces 160 and 178 on supporting body 112, wherein loop packets 168₁ and 170₁ in each case loop around a coupling means 148₁ and 148₃ on supporting body 112 and a coupling means 150 and 152 on end cap sections 114 and 116.

FIG. 8 shows a cross-sectional view through cross-sectional line VII-VII from FIG. 7.

A coupling section formation 180 on end cap section 116 is provided between coupling formations 162 and 166 of supporting body 112. Coupling formation 180 of end cap section 116 engages between coupling formations 162 and 166 of supporting body 112. Loop packet arrangement 168 comprises four loop packets 168₁, 168₂, 168₃ and 168₄, which are each coupled with supporting body 112 by means of coupling means 148₁ and 148₂ and with end cap section 116 by means of coupling means 152.

In other words, loop packets 168₁ and 168₄ accommodated in coupling formations 162 and 166 are coupled with supporting body 112 by means of coupling means 148₁ and 148₂, whilst loop packets 168₂ and 168₃ in coupling formation 180 are coupled with end cap section 116. At their respective other end, loop packets 168₁ and 168₄ are coupled with end cap section 116 and, as can be seen in FIG. 6, loop packets 168₂ and 168₃ are coupled with supporting body 112.

Each of loop packets 168₁, 168₂, 168₃ and 168₄ is accordingly connected in each case to supporting body 112 and end cap section 114, wherein the coupling points of loop packets 168₁, 168₂, 168₃ and 168₄ on supporting body 112 and respectively on end cap sections 114 and 116 in each case alternate in the direction of rotational axis D, as shown in FIGS. 5 and 8. Despite their alternating coupling points, loop packets 168₁, 168₂, 168₃ and 168₄ run parallel to one another in the unloaded state of rotary piston 110. In the event of a deflection or displacement of end cap section 114 relative to supporting body 112, loop packets 168₁, 168₂, 168₃ and 168₄ of loop packet arrangement 168 can intersect on account of their alternating coupling in the direction of rotational axis D.

Loop packet arrangements 168 and 180 are once again embedded in elastomer cushioning layer 118.

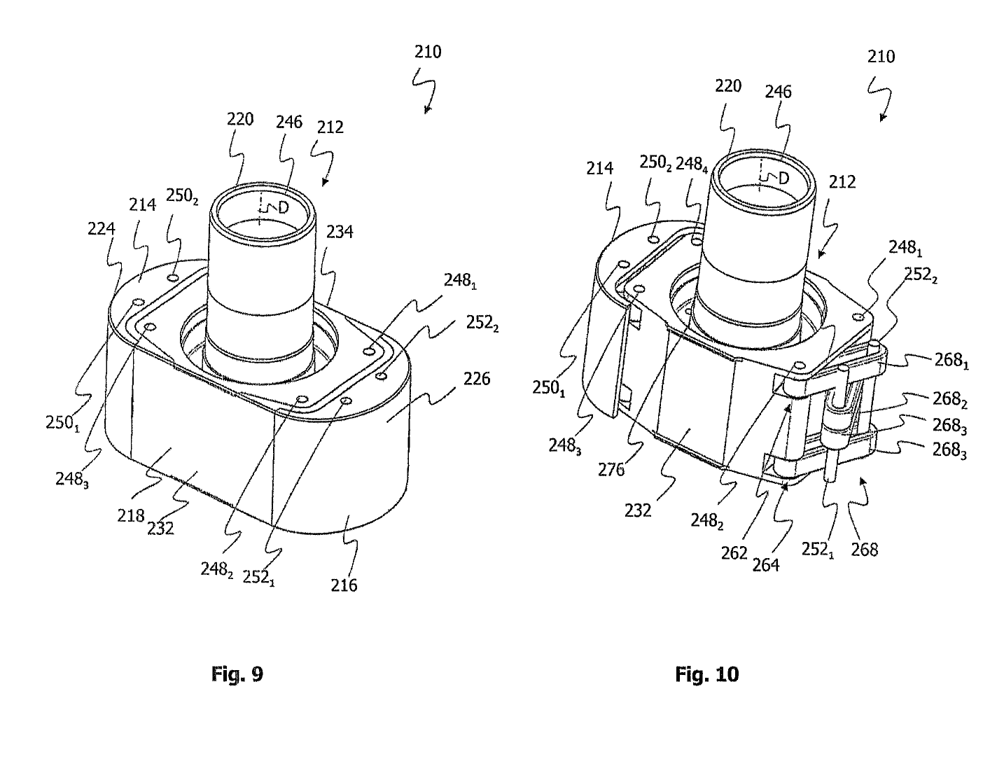

FIG. 9 shows a perspective view of a rotary piston 210 according to a third embodiment of the invention. Once again, the same reference numbers are used as above, but increased by 200.

Rotary piston 210 comprises a supporting body 212. Supporting body 212 is in contact with end cap sections 214 and 216 via a cushioning layer 218 surrounding supporting body 212. The hub of rotary piston 210 is formed by an annular section 246 and an opening 220 formed in tubular section 246.

Outer faces 232 and 234 of supporting body 212 are covered with rubber-elastic casing 218, just as in the case of the embodiments of the invention described above.

Coupling means 248₁, 248₂, 248₃ and 248₄ are provided on supporting body 212. End cap sections 214 and 216 are provided with corresponding coupling means 250₁, 250₂, 252₁ and 252₂.

For further explanation, reference is made in the following, by way of example, in particular to coupling means 252₁ and 252₂ of end cap section 216.

FIG. 10 shows a partially broken-away, perspective view of rotary piston 210 according to the third embodiment of the invention.

Coupling means 248₁, 248₂ on supporting body 212 and coupling means 252₁ and 252₂ of end cap section 216 (FIG. 9) are connected together by means of loop packets 268₁, 268₂, 268₃ and 268₄. Loop packets 268₁, 268₂, 268₃ and 268₄ of loop packet arrangement 268 in each case loop around one of coupling means 248₁, 248₂ and one of coupling means 252₁ and 252₂ of end cap section 216. For example, loop packet 268₁ loops around coupling means 248₂ on supporting body 212 and coupling means 252₂ of end cap section 216.

Loop packets 268₁ and 268₄ run parallel to one another just like loop packets 268₂ and 268₃, so that loop packets 268₁ and 268₄ intersect with loop packets 268₂ and 268₃. Loop packets 268₁, 268₂, 268₃ and 268₄ in each case loop around, as mentioned, a coupling means 248₁, 248₂ on supporting body 212. Loop packets 268₁, 268₂, 268₃ and 268₄ then extend in the direction of end cap section 216 (FIG. 9) and intersect, before they loop around coupling means 252₁ and 252₂ of end cap section 216 assigned to them.

Loop packets 268₁, 268₂, 268₃ and 268₄ are accommodated in the coupling formations, only coupling formations 262 and 264 being able to be seen in FIG. 10. Coupling formations 262 and 264 are here recesses formed in supporting body 212, in which recesses loop packets 268₁ and 268₄ are coupled with supporting body 112 by means of coupling means 248₁ and 248₂. Coupling means 250₁, 250₂, 252₁ and 252₂ extend continuously through end cap sections 214 and 216.

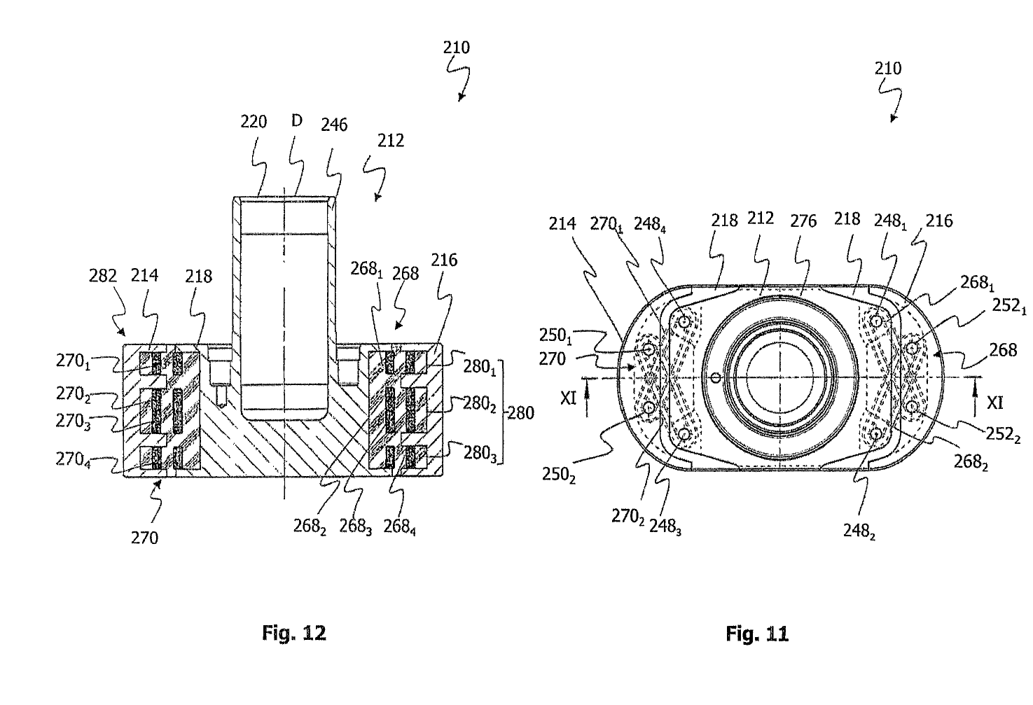

FIG. 11 shows a plan view of rotary piston 210.

Although represented concealed, loop packet arrangements 268 and 270 with mutually intersecting loop packets 268₁, 268₂ and 270₁, 270₂ can be seen in FIG. 11.

Loop packets 268₁, 268₂ and 270₁, 270₂ on the one hand loop around coupling means 248₁, 248₂, 248₃, 248₄ on supporting body 212 and on the other hand coupling means 250₁ and 250₂ of end cap section 214 and respectively coupling means 252₁ and 252₂ of end cap section 216, wherein loop packets 268₁, 268₂ and 270₁, 270₂ intersect in a region between coupling means 248₁, 248₂, 248₃, 248₃ and 250₁, 250₂ and respectively 252₁ and 252₂.

FIG. 12 shows a cross-sectional view through cross-sectional line XI-XI from FIG. 11.

According to a second embodiment of the invention, supporting body 212 of rotary piston 210 is constituted in one piece. Loop package arrangements 268 and 270 are completely embedded in elastomer cushioning layer 218.

A coupling formation 280 is formed on end cap section 216, as shown in FIG. 12. The same applies to end cap section 214 with coupling formation 282. Coupling formation 280 is formed by recesses 280₁, 280₂, 280₃ in end cap section 216. Loop packets 268₁, 268₂, 268₃ and 268₄ of loop package arrangements 268 and 270 are guided through coupling formation 280 at least in sections in the region of end cap sections 216.

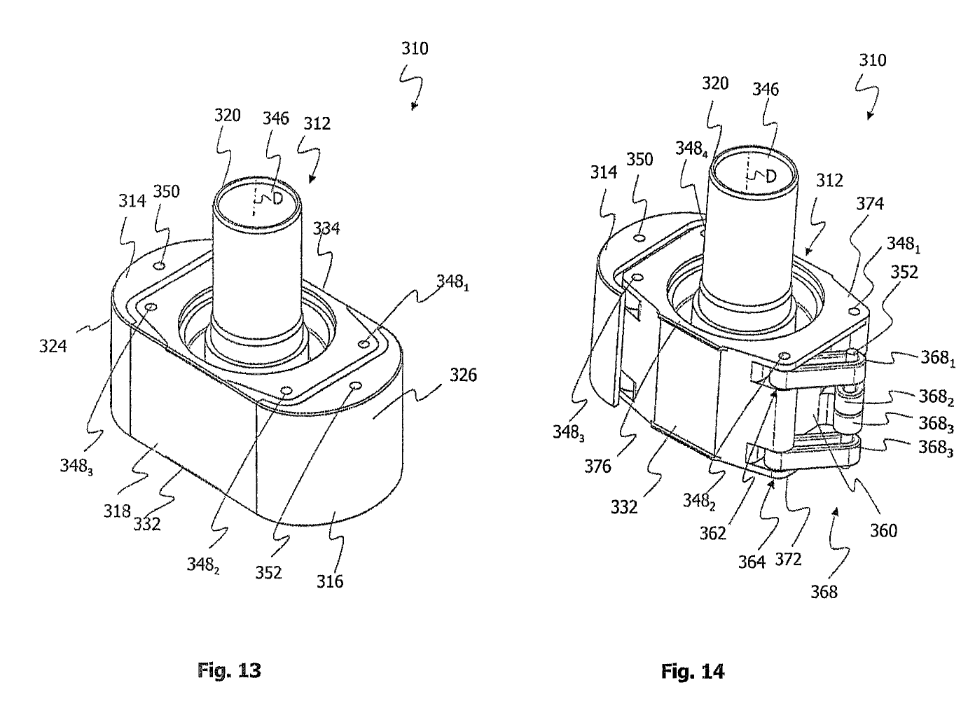

FIG. 13 shows a perspective view of a rotary piston 310 according to a fourth embodiment of the invention. Once again, the same reference numbers are used as above, but increased by the number 300.

Rotary piston 310 comprises a supporting body 312, which is surrounded by a rubber-elastic cushioning layer 318 and is connected via the latter to end cap sections 314 and 316.

End cap sections 314 and 316 each comprise a coupling means 350, 352. Supporting body 312 comprises in total four coupling means 348₁, 348₂, 348₃, 348₃, whereof two coupling means 350 and 352 are assigned in each case to end cap sections 314, 316.

FIG. 14 shows a partially broken-away, perspective view of rotary piston 310.

Coupling formations 362 and 364 are constituted in the form of recesses on face 360 of supporting body 312. Coupling formations 362 and 364 accommodate loop packets 368₁, 368₄ for coupling with coupling means 348₁. According to this embodiment, coupling means 348₁, 348₂ are also provided on opposite ends 372 and 374 of face 360.

Coupling means 348₁, 348₂ on supporting body 312 are each looped around by two loop packets 368₁, 368₄ and respectively 368₂, 368₃. The two—in the direction of rotational axis D—outer loop packets 368₁, 268₄ loop around coupling means 348₂ and inner loop packets 368₂, 368₃ loop around coupling means 348₁. All loop packets 368₁, 368₂, 368₃, 368₄ of loop packet arrangement 368 loop around coupling means 352 of end cap section 316 (FIG. 13). Loop packets 368₁, 368₂, 368₃, 368₄ for looping around coupling means 352 thus converge at coupling means 352 of end cap section 316.

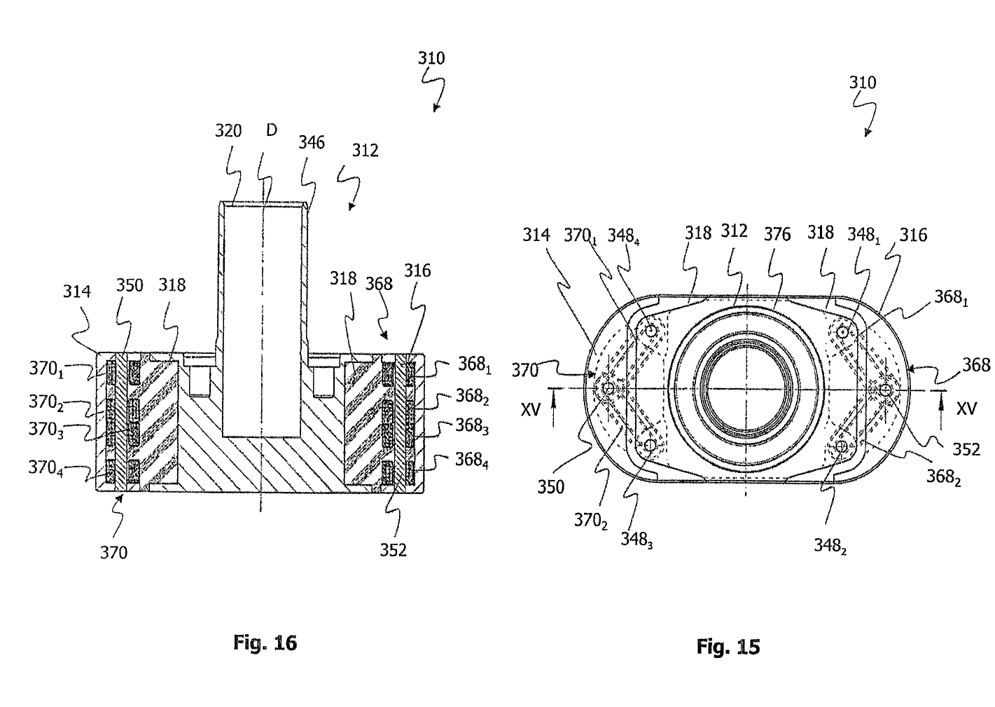

FIG. 15 shows a plan view of rotary piston 310, from which the guidance of the loop packets of loop packet arrangements 368 and 370 can be seen. Loop packets 368₁, 368₂ and 370₁, 370₂ form a V-shape by the looping-around of coupling means 348₁, 348₂, 348₃, 348₄ on supporting body 312 and coupling means 350 and 352 on end cap sections 314, 316.

FIG. 16 shows a cross-sectional view of rotary piston 310 through cross-sectional line XV-XV from FIG. 15.

It is possible to see in FIG. 16 coupling means 350 and 352 on end cap sections 314 and 316, which are each looped around by loop packets 368₁, 368₂, 368₃, 368₄ and 370₁, 370₂, 370₃, 370₄ of the loop package arrangements 368 and 370. Coupling means 350, 352 extend completely through end cap sections 314, 316. Loop packet arrangements 368 and 370 are once again encased by elastomer cushioning layer 318.

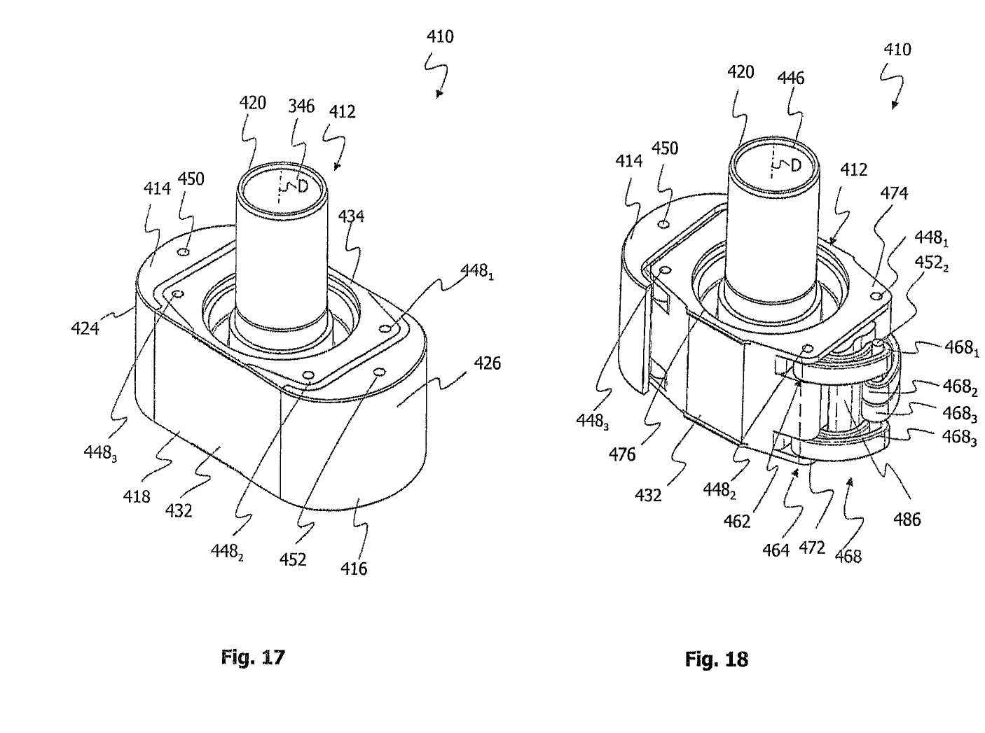

FIG. 17 shows a perspective view of a rotary piston 410 according to a fifth embodiment of the invention. The structure and mode of functioning of rotary piston 410 according to the fifth embodiment of the invention correspond for the most part to the structure of rotary piston 310 according to the fourth embodiment of the invention. FIG. 17 will not therefore be gone into further, but rather reference will be made directly to FIGS. 18 to 20, which illustrate the differences with respect to the previously described fourth embodiment of the invention. Once again, the same reference numbers are used as above, but increased by the number 400.

In FIG. 18, which shows a partially broken-away perspective view of rotary piston 410, it is possible to see a guide element 486, about which loop packets 468₁, 468₂, 468₃, 468₄ are guided in the direction of coupling means 452 on end cap section 416. Loop packets 468₁, 468₂, 468₃, 468₄ of loop packet arrangement 468 run correspondingly curved from coupling means 448₁, 448₂ around guide elements 486 in the direction of coupling means 452 and loop around coupling means 452.

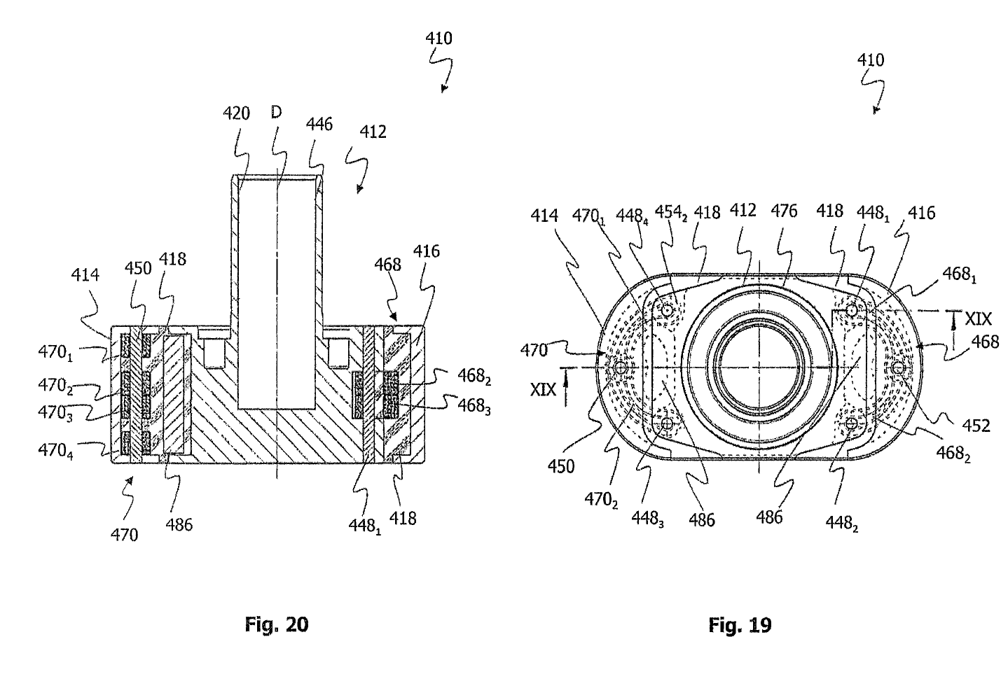

FIG. 19 shows a plan view of rotary piston 410.

The curved course of loop packets 368₁, 368₂ and 370₁, 370₂ of loop packet arrangements 468 and 470 around guide elements 486 can clearly be seen from FIG. 19. Guide elements 486 are arched in the direction of rotational axis D and essentially have the shape of a kidney. With their shape, guide elements 486 support tilting of end cap sections 414 and 416 relative to supporting body 412 about rotational axis D.

FIG. 20 shows a cross-sectional view through cross-sectional line XIX-XIX from FIG. 19.

In FIG. 20, it is possible to see on the one hand coupling means 448₁ on supporting body 412 and on the other hand coupling means 450 on end cap section 414. Coupling means 448₁ is looped around by loop packets 468₂, 468₃ of loop packet arrangement 468, i.e. by—in the direction of rotational axis D—inner loop packets 468₂, 468₃ (FIG. 18). Coupling means 448₁ extend continuously through supporting body 412.

Coupling means 450 on end cap section 414 is, as mentioned, looped around by all loop packets 470₁, 470₂, 470₃, 470₄ of loop packet arrangement 470.

Guide element 486, like loop packet arrangements 468 and 480, is completely embedded in elastomer cushioning layer 480.

Since loop packets 468₁, 468₂, 468₃, 468₄ and 470₁, 470₂, 470₃, 470₄ are guided in a curved manner around guide elements 486 and guide elements 486 are themselves arched in the direction of rotational axis D, guide elements 486 enable, in the case of loading of rotary piston 410, a roll-off movement of end cap sections 414, 416 relative to supporting body 412 with simultaneous compression of elastomer cushioning layer 418. The roll-off movement is enabled due to the curvature of guide elements 486 in a direction around rotational axis D.

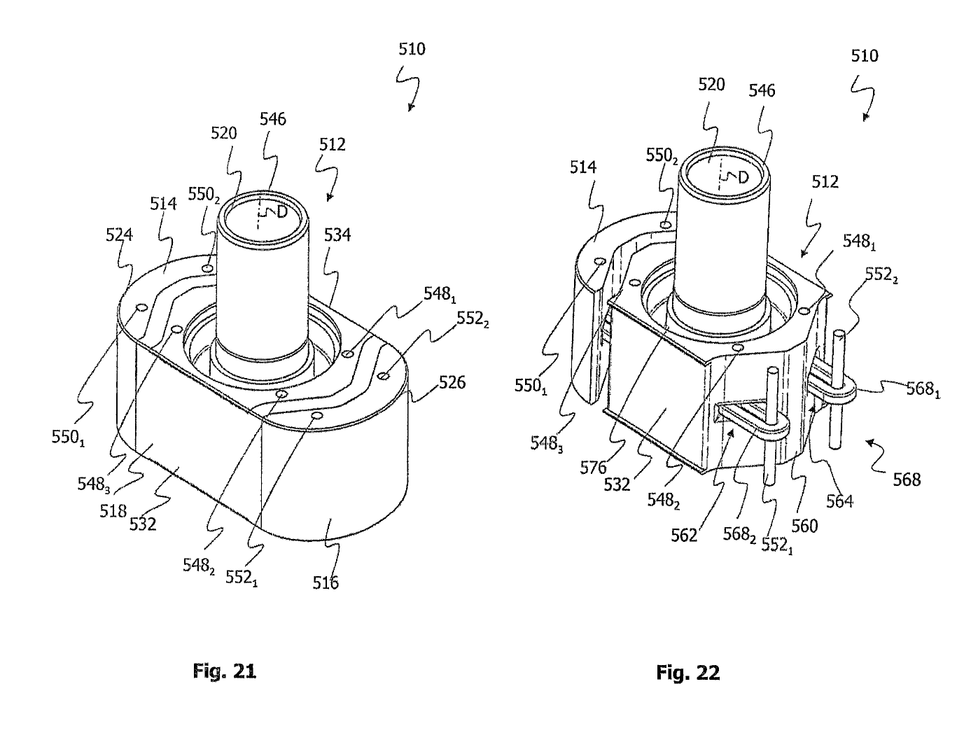

FIG. 21 shows a perspective view of a rotary piston 510 according to a sixth embodiment of the invention. Once again, the same reference numbers are used as above, but increased by the number of 500.

FIG. 21 shows supporting body 512 of rotary piston 510 and end cap sections 514 and 516, which are connected to supporting body 512 via elastomer cushioning layer 518. Elastomer cushioning layer 518 surrounds the peripheral faces of supporting body 512.

FIG. 22 shows a partially broken-away, perspective view of rotary piston 510.

Loop packets 568₁, 568₂ of loop packet arrangement 568 loop in each case in pairs around one of coupling means 548₁, 548₂ on supporting body 512 and one of coupling means 552₁, 552₂ on end cap section 516 (FIG. 31). Loop packets 568₁ and 568₂ are assigned respectively to a coupling means 548₁, 548₂ and a coupling means 552₁, 552₂.

Supporting body 512 comprises coupling formations 562 and 564 in the form of recesses in face 560. Loop packets 568₁, 568₂ extend through the recesses or coupling formations 562 and 564 and thereby loop around coupling means 548₁, 548₂. Loop packets 568₁, 568₂ then extend in the direction of coupling means 552₁, 552₂ on end cap section 516 and loop around the latter.

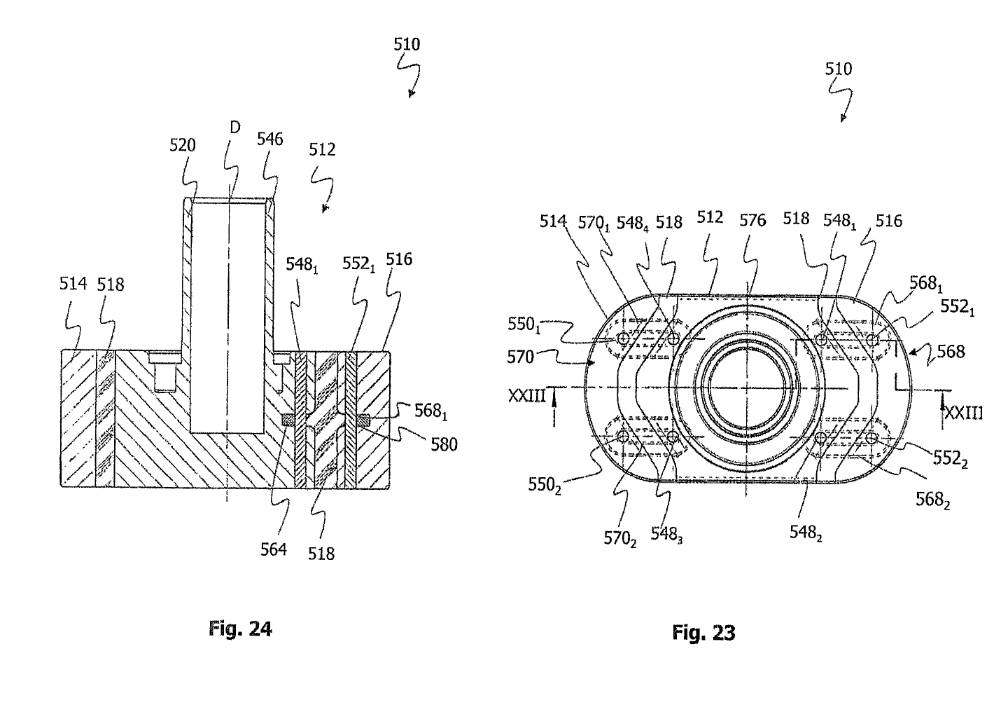

FIG. 23 shows a plan view of rotary piston 510.

According to this embodiment of the invention, loop packet arrangements 568 and 570 are formed respectively by two loop packets 568₁, 568₂ and 570₁, 570₂, which run parallel to one another and both lie in a plane normal to rotational axis D. As already mentioned, loop packet 568₁ for example loops around coupling means 548₁ on supporting body 512 and coupling means 552₁ on end cap section 516. The same applies to the other loop packets 568₂ and 570₁, 570₂.

FIG. 24 shows a cross-sectional view of rotary piston 510 through cross-sectional line XXIII-XXIII from FIG. 23.

Just like recess 564 in supporting body 512, there is formed in end cap section 516 a recess 580, in which loop packet 568₁ is accommodated in sections.

Supporting body 512 and end cap section 516 are penetrated by openings, in which coupling means 548₁ and 552₁ are accommodated. Loop packet 568₁ can be inserted into recess 564 of supporting body 512 and into recess 580 on end cap section 516. Coupling means 548₁ and 552₁ are then inserted into corresponding openings in order to couple loop packet 568₁ both with supporting body 512 and with end cap section 516.

Loop packet 568₁ is embedded in elastomer cushioning layer 518 in the region between coupling means 548₁ and 552₁.

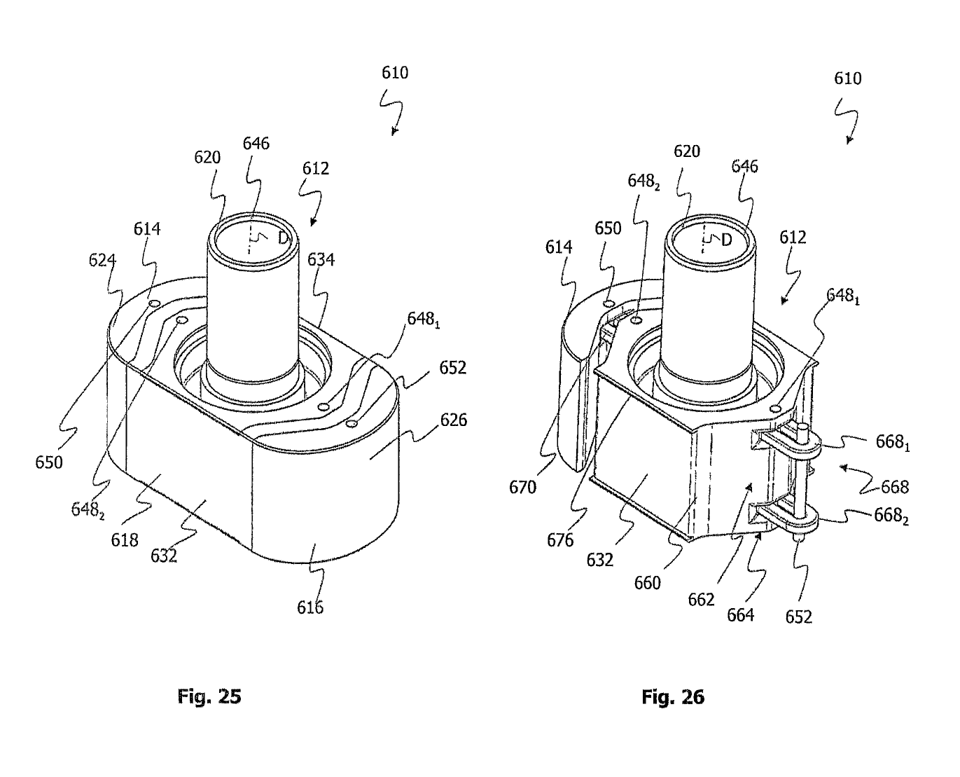

FIG. 25 shows a perspective view of a rotary piston 610 according to a seventh embodiment of the invention. The same reference numbers are used as above, but increased by the number 600.

Rotary piston 610 comprises a supporting body 612, which is surrounded by a rubber-elastic cushioning layer 618 and is connected via the latter to end cap sections 614 and 616. End cap sections 614 and 616 each comprise a coupling means 650, 652. Supporting body 612 comprises two coupling means 648₁, 648₂, which are assigned respectively to coupling means 650 and 652 of end cap sections 614, 616.

FIG. 26 shows a partially broken-away, perspective view of rotary piston 610.

In supporting body 612, it is possible to see recesses 662, 664 in face 660 of supporting body 612. Recesses 612, 624 are disposed spaced apart from one another, i.e. offset with respect to one another, in the direction of rotational axis D. Recesses 662, 664 lie however in alignment in the direction of rotational axis D. Loop packets 668₁ and 668₂ of loop packet arrangement 668 loop around coupling means 648₁ on supporting body 612 and coupling means 652 on end cap section 616 (FIG. 25). The two loop packets 668₁ and 668₂ thus together loop around coupling means 648₁ and 652.

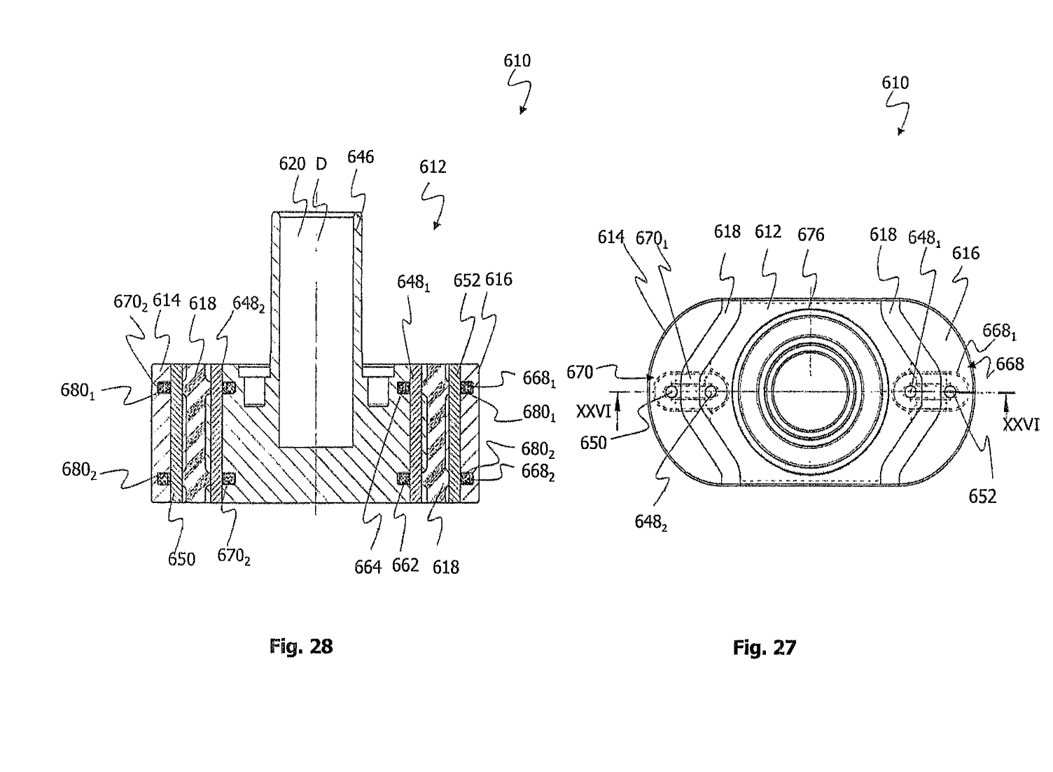

FIG. 27 shows a plan view of rotary piston 610.

In FIG. 27, only one loop packet 668₁ and 670₁ of loop packet arrangement 668 and 670 can be seen in each case, since loop packets 668₁ and 670₁ are disposed one above the other in the direction of rotational axis D, so that they lie in alignment as viewed in the direction of rotational axis D.

FIG. 28 shows a cross-sectional view of rotary piston 610 through cross-sectional line XVII-XVII from FIG. 27.

Recesses 662, 664 on supporting body 612 and recesses 680₁ and 680₂ on end cap sections 614 and 616 accommodate loop packets 668₁, 668₂ and 670₁, 670₂. Loop packets 668₁, 668₂ and 670₁, 670₂ are coupled by coupling means 648₁, 648₂ with supporting body 612 and by coupling means 650, 652 with end cap sections 614, 616. The sections of loop packets 668₁, 668₂ and 670₁, 670₂ which are not accommodated in recesses 662, 664 and 680₁, 680₂ are embedded in elastomer cushioning layer 618. Coupling means 648₁, 648₂ and coupling means 650, 652 extend in the axial direction completely through end cap sections 614, 616 and supporting body 612.

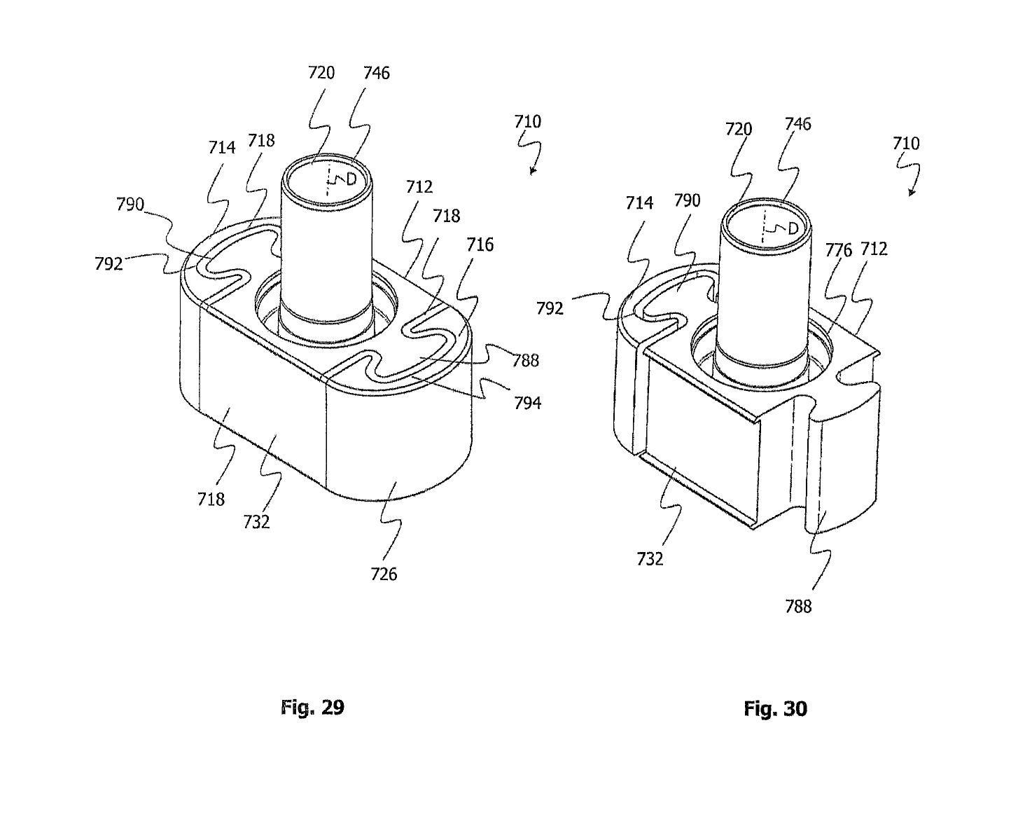

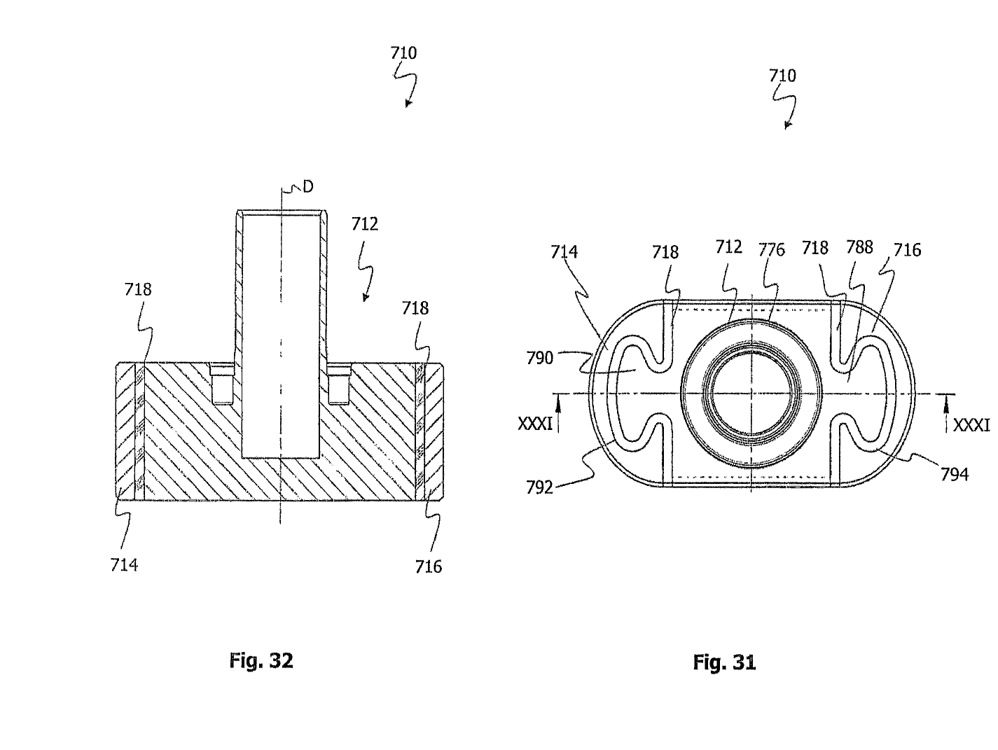

FIGS. 29 to 32 show various views of a rotary piston 710 according to the eighth embodiment of the invention. The same reference numbers are used as above, but increased by the number 700.

Rotary piston 710 comprises supporting body 712, which is surrounded by elastomer cushioning layer 718. Elastomer cushioning layer 718 connects supporting body 712 to end cap sections 714 and 716.

It can clearly be seen in FIG. 29 that supporting body 712 according to this embodiment of the invention is connected by a form-fit connection to end cap sections 714 and 716. For this purpose, there are formed on supporting body 712 projections 788 and 790, which are accommodated in corresponding recesses 792 and 794 on end cap sections 714 and 716. Elastomer cushioning layer 718 extends between projections 788, 790 and corresponding recesses 792, 794.

Projections 788 and 790 on supporting body 712 are formed in the axial direction of rotational axis D over the whole extension of supporting body 712 (FIG. 30). The same applies to recesses 792, 794 in end cap sections 714 and 716.

When FIG. 31 is viewed more closely, it can be seen that the form-fit connection between supporting body 712 and end cap sections 714 and 716 is produced by a separate dovetailed connection. Projections 788 and 790 essentially have a rounded dovetailed shape just like recesses 792, 794. To assist the deflection capability or tilting about rotational axis D of end cap sections 714 and 716 relative to supporting body 712, both projections 788, 790 and recesses 792 and 794 are constituted rounded. Displacements or deflections of end cap sections 714 and 716 relative to supporting body 712 are limited according to a predetermined deflection path by the shape of projections 788 and 790 and recesses 792 and 794, since end cap sections 714 and 716 can rest on or find support on projections 788 and 790 thereby compressing elastomer cushioning layer 718. During operation of rotary piston 710, elastomer cushioning layer 718 is thus acted upon primarily by compressive forces and only by slight shearing forces.

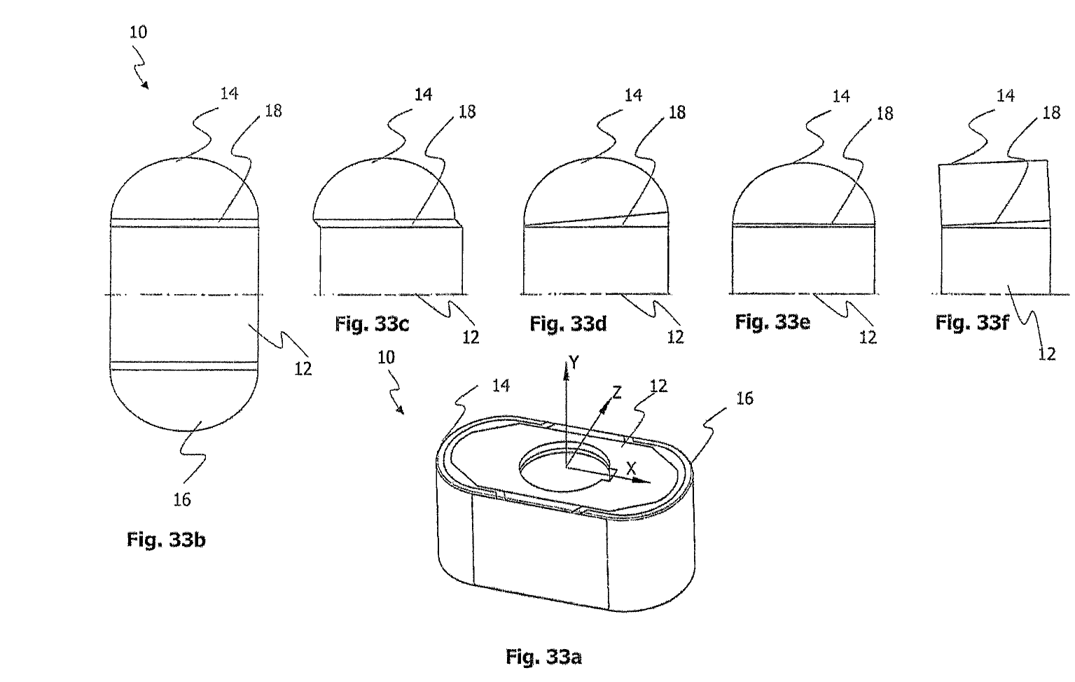

FIGS. 33a to 33f show various possible deflections of end cap sections 14, 16 relative to supporting body 12.

FIG. 33a shows, by way of example, a perspective you of a first embodiment of the invention, in which a coordinate system for better orientation is represented.

FIG. 33b shows the normal position of rotary piston 10.

FIG. 33c shows a displacement of end cap section 14 relative to supporting body 12 in the direction of the Z-axis (FIG. 33a), a so-called shear load.

FIG. 33d shows tilting of end cap section 14 about the Y-axis (FIG. 33a).

FIG. 33e shows a compression or crushing of cushioning layer 18 due to a movement of end cap section 14 in the direction of supporting body 12, i.e. in the direction of the X-axis (FIG. 33a).

FIG. 33f shows tilting of end cap section 14 relative to supporting body 12 about the Z-axis (FIG. 33a).

All the embodiments described above enable an articulated and flexible connection of the end cap sections to the supporting body, so that straight deflections or displacements of the end cap sections in the direction of the rotational axis, normal to the rotational axis and about the rotational axis of the rotary piston are permitted, which contribute to a reduction in the wear on the rotary piston and an increase in the mobility of solids in the rotary piston pump.

1. A rotary piston for a rotary piston pump, the rotary piston comprising:
at least one supporting body, through which a rotational axis of the rotary piston extends, and
at least one dimensionally stable end cap section, which is disposed radially outwards from the at least one supporting body and is connected flexibly to the at least one supporting body.

2. The rotary piston according to claim 1, wherein the at least one supporting body of the rotary piston and the at least one end cap section are connected to one another via at least one elastomer cushioning layer.

3. The rotary piston according to claim 1, further comprising at least two end cap sections, which are connected to one another by means of at least one loop packet.

4. The rotary piston according to claim 3, wherein the at least one loop packet connecting the at least two end cap sections extends along the at least one supporting body, wherein the at least two end cap sections each comprise at least one coupling means, around which the at least one loop packet is looped.

5. The rotary piston according to claim 1, wherein the at least one supporting body and the at least one end cap section are connected to one another by means of at least one loop packet.

6. The rotary piston according to claim 5, wherein the at least one supporting body and the at least one end cap section are connected to one another by means of at least one loop packet arrangement.

7. The rotary piston according to claim 6, wherein the loop packets of the at least one loop packet arrangement are disposed on the at least one supporting body and the at least one end cap section in such a way that at least two of the loop packets of the at least one loop packet arrangement intersect.

8. The rotary piston according to claim 6, wherein the loop packets of the at least one loop packet arrangement are disposed on the at least one supporting body and the at least one end cap section in such a way that the loop packets of the at least one loop packet arrangement run parallel to one another between the at least one supporting body and the at least one end cap section.

9. The rotary piston according to claim 6, wherein at least one coupling means is provided in each case on the at least one supporting body and the at least one end cap section, wherein the at least one coupling means of the at least one supporting body and the at least one coupling means of the at least one end cap section are looped around by the at least one loop packet of the at least one loop packet arrangement.

10. The rotary piston according to claim 9, wherein all the loop packets of the at least one loop packet arrangement loop around the at least one coupling means on the at least one end cap section.

11. The rotary piston according to claim 5, wherein the at least one loop packet is guided in a curved manner around at least one guide element.

12. The rotary piston according to claim 3, wherein the at least one loop packet is embedded at least in sections in at least one elastomer cushioning layer, the at least one elastomer cushioning layer connecting the at least one supporting body of the rotary piston to the at least one end cap section.

13. The rotary piston according to claim 1, wherein the at least one supporting body and the at least one end cap section are connected to one another in a form-fit manner.

14. The rotary piston according to claim 13, wherein the at least one supporting body and the at least one end cap section comprise, for the purpose of producing a form-fit connection, at least one complementary pair of at least one projection and at least one recess.

15. A rotary piston pump comprising:
a rotary piston having at least one supporting body, through which a rotational axis of the rotary piston extends, and at least one dimensionally stable end cap section, which is disposed radially outwards from the at least one supporting body and is connected flexibly to the at least one supporting body.
